(19) United States
(12) Patent Application Publication
(10) Pub. No.: US 2021/0344705 A1
(43) Pub. Date: Nov. 4, 2021

(54) METHOD FOR REGISTERING EDGE COMPUTING ACCESS AND AN EDGE COMPUTING NODE DEVICE

(71) Applicant: Shenzhen Jingjiang Yunchuang Technology Co., Ltd., Shenzhen (CN)

(72) Inventors: XUE-QIN ZHANG, Shenzhen (CN); JUKA OH, Shenzhen (CN)

(21) Appl. No.: 17/072,295

(22) Filed: Oct. 16, 2020

(30) Foreign Application Priority Data
Apr. 30, 2020 (CN) 202010368079.9

(51) Int. Cl. H04L 29/06; H04L 29/08

(52) U.S. Cl. CPC H04L 63/1441; H04L 67/1036; H04L 63/20; H04L 63/1416

(57) ABSTRACT

A method for registering edge computing access which is applied in an edge computing node device, receives data sent by an external device and carry out a security check on the data, data which passes the security check being registered. The edge computing node device records an identification number of the sending external device, records a status of a registration mode of the external device, records a state of the data's calculation algorithm, sets the data's calculation algorithm or calculation model, sets output interface of the data's calculation results, and sets an identification number of an output device that outputs the data. The edge computing node device can access and process the data after registration.

### CROSS-REFERENCE TO RELATED APPLICATIONS

This application claims priority to Chinese Patent Application No. 202010368079.9 filed on Apr. 30, 2020, the contents of which are incorporated by reference herein.

### FIELD

The subject matter herein generally relates to a communication field, especially to a method for registering edge computing access and an edge computing node device.

### BACKGROUND

Edge computing can reduce pressure on the cloud platform, avoid data congestion, reduce latency, and solve massive amounts of information access by devices applying to the cloud platform. However, a registration process for existing edge computing data access is complex and there is no unified data access registration process, which makes the edge computing data access process inefficient and very high in power consumption.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a running environment of an edge computing node device.

FIG. 2 is a block diagram of an embodiment of the edge computing node device of FIG. 1.

FIG. 3 is a block diagram of an embodiment of a registration system for edge computing.

FIG. 4 is a block diagram of another embodiment of a registration system.

FIG. 5 is a flowchart of an embodiment of a method for registering edge computing access.

FIG. 6 is a flowchart of another embodiment of a method for registering edge computing access.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or other storage devices. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

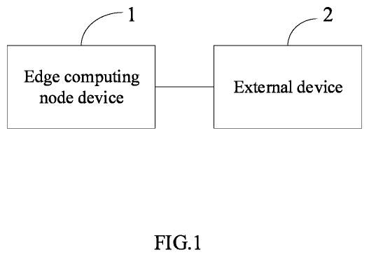

FIG. 1 illustrates a running environment of an edge computing node device 1. The edge computing node device 1 communicates with an external equipment 2. The edge computing node device 1 receives data sent by the external device 2, processes the data sent by the external device 2, and outputs a result of processing the data. In one embodiment, the external device 2 can be an end device, for example, the external device 2 may be a data collector, a data acquisition card, a sensor, or an image collector (e.g. a camera, an endoscope, a light field camera). In another embodiment, the external device 2 can be an edge computing device, for example, the external device 2 can be another edge computing node device or an edge cloud. In other embodiment, the external device 2 can also be a cloud platform, for example, the external device 2 can be a cloud platform server or a data center. In one embodiment, the edge computing node device 1 is a logical abstraction of the basic ability of an edge gateway, an edge controller, and edge server, and has functions of real-time data analysis, local data storage, and real-time network connection.

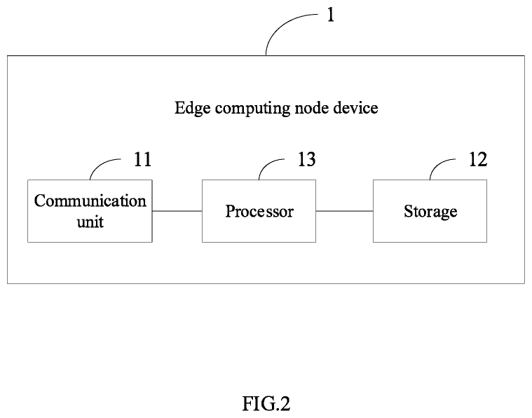

FIG. 2 illustrates the edge computing node device 1. The edge computing node device 1 includes a communication unit 11, a storage 12, a processor 13. In one embodiment, the processor 13 connects to the communication unit 11 and the storage 12. In one embodiment, the edge computing node device 1 communicates with the external device 2 by the communication unit 11. In one embodiment, the communication unit 11 is a wireless communication module, for example, the communication unit 11 can be a 4G communication module, a 5G communication module, a WIFI communication module, a LORA communication module or an NBIOT communication module. In another embodiment, the communication unit 11 can be a wired communication module, for example, the communication unit 11 can be a PROFIBUS, a MODBUS, a CAN bus, an ETHERCAT bus, a fiber optic line, or an ETHERNET.

The storage 12 stores data or soft code of the edge computing node device 1. In one embodiment, the storage 12 can include various types of non-transitory computer-readable storage mediums. For example, the storage 12 can be an internal storage system of the edge computing node device 1, such as a flash memory, a random access memory (RAM) for the temporary storage of information, and/or a read-only memory (ROM) for permanent storage of information. In another embodiment, the storage 12 can also be an external storage system of the edge computing node device 1, such as a hard disk, a storage card, or a data storage medium. In one embodiment, the processor 13 can be a central processing unit, a common processor, a digital signal processor, a dedicated integrated circuit, a ready-made programmable gate array, another programmable logic device, discrete door or transistor logic device, discrete hardware component, or the like. In another embodiment, the processor 13 can be any conventional processor. The processor 13 can also be a control center of the edge computing node device 1, using various interfaces and lines to connect the various parts of the external device 2.

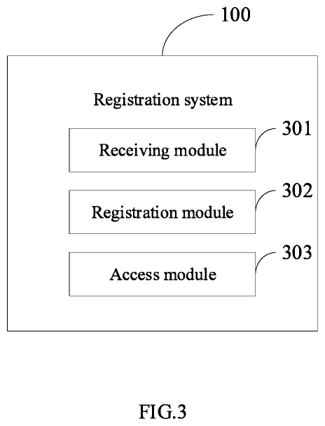

FIG. 3 illustrates a registration system 100. The registration system 100 includes a receiving module 301, a registration module 302, and an access module 303. The modules 301-303 of the registration system 100 can be collections of software instructions. In the present embodiment, the receiving module 301, the registration module 302, and the access module 303 are stored in the storage 12 of the edge computing node device 1 and executed by the processor 13 of the edge computing node device 1. In another embodiment, the receiving module 301, the registration module 302, and the access module 303 are program segments or code in the processor 13 of the edge computing node device 1.

The receiving module 301 receives the data sent by the external device 2 and carries out a security check on the data.

In one embodiment, the receiving module 301 receives the data by the communication unit 11. The receiving module 301 selects a checking mode from three checking modes of virus scanning, whitelist scanning, and security authentication, and checks the data according to the selected checking mode, records abnormal data when a security check gives an abnormal result, and distinguishes and reports the abnormal data. In one embodiment, when checking the data according to the checking mode of virus scanning, the receiving module 301 compares the data with virus files in a virus database and acquires the security check result, and determines that the data are abnormal if the result is that the data are consistent with virus files in the virus database, otherwise determining that the data are not abnormal. In one embodiment, when checking the data according to the checking mode of whitelist scanning, the receiving module 301 compares the data with lists in a whitelist database and acquires the security check result, determining that the data are abnormal when the security check result of the data are that the data are consistent with the lists in the whitelist database, otherwise determining that the data are not abnormal. In one embodiment, when checking the data according to the checking mode of security authentication, the receiving module 301 determines that the data are abnormal when the data does not pass security authentication, otherwise determining that the data are not abnormal.

The registration module 302 registers the data indicated as normal by the security check.

In one embodiment, the registration module 302 records identification number of the external device 2 that sends the data, records a status of the registration mode of the external device 2, records a state of the data's calculation algorithm, sets the data's calculation algorithm or calculation model, sets output interface of the data's calculation results, and sets identification number of an output device that outputs the data.

In one embodiment, the data includes the identification number of the external device 2, and the registration module 302 records the identification number of the external device 2 when registering the data checked as normal. In one embodiment, the identification number of the external device 2 includes, but is not limited to, a device name, an application field, a company name, and a device number. For example, when the external device 2 is a cloud platform, the identification number of the external device 2 can be Platform_Field_Company Number. When the external device 2 is an edge computing node device, the identification number of the external device 2 can be EdgeNode_Field_Company_Number. When the external device 2 is an instrument, the identification number of the external device 2 can be T_Instrument_Field_Company_Number, and when the external device 2 is a sensor, the identification number of the external device 2 can be T_Instrument_Field_Company_Number.

In one embodiment, the data includes the status of the registration mode of the external device 2. The status of the registration mode of the external device 2 includes a binding registration mode and a non-binding registration mode. The binding registration mode means that an edge calculation service of the data are fixed, such that a calculation algorithm or a calculation model of the data cannot be changed. In one embodiment, the binding registration mode is suitable for a single terminal device with a relatively simple function, for example, the binding registration mode is suitable for a collector, a sensor, or a controller. In one embodiment, the edge computing node device 1 includes a calculation algorithm or calculation model, and when the data sent by an external device 2 is registered, the registration module 302 registers the calculation algorithm or the calculation model in the edge computing node device 1 as the calculation algorithm or calculation model of the data. When the data are registered as the binding registration mode, the calculation algorithm or calculation model of the data are fixed and cannot be changed. In one embodiment, the edge computing node device 1 includes a number of calculation algorithms or calculation models in the edge computing node device 1. When the data sent by an external device 2 is registered, the registration module 302 selects one calculation algorithm or one calculation model from the number of calculation algorithms or calculation models and registers the selected calculation algorithm or the calculation model in the edge computing node device 1 as the calculation algorithm or calculation model of the data. In another embodiment, the edge computing node device 1 includes a number of calculation algorithms or calculation models in the edge computing node device 1, and when the data sent by an external device 2 is registered, the registration module 302 selects at least two calculation algorithms or one calculation models from the number of calculation algorithms or calculation models and registers both of the selected calculation algorithms or the calculation models as the calculation algorithm or calculation model of the data.

In one embodiment, the non-binding registration mode means that the edge calculation service of the data can be changed, such that the calculation algorithm or the calculation model of the data can be changed. In one embodiment, the non-binding registration method is suitable for a cloud computing platform, a data center, an edge server, or an edge computing node device. In one embodiment, the edge computing node device 1 includes the computational algorithm or the calculation model. When the data sent by an external device 2 is registered, the registration module 302 registers the calculation algorithm or calculation model in the edge computing node device 1 as the calculation algorithm or calculation model of the data. When the data are registered in the non-binding registration mode the calculation algorithm or calculation model of the data are able to be changed.

In one embodiment, the edge computing node device 1 includes a number of calculation algorithms or calculation models. When the data sent by an external device 2 is registered, the registration module 302 selects at least one calculation algorithm or one calculation model from the number of calculation algorithms or calculation models and registers the at least one calculation algorithm or the calculation model in the edge computing node device 1 as the calculation algorithm or calculation model of the data.

In one embodiment, the status of the registration mode is 0 indicates that the registration method is the binding registration mode, and the status of the registration mode is 1 indicates that the registration mode is the nun-binding registration mode. In another embodiment, the status of the registration mode is 0 indicates that the registration method is the nun-binding registration mode, and the status of the registration mode is 1 indicates that the registration mode is the binding registration mode.

In one embodiment, the data includes the state of the data's calculation algorithm. The state of the data's calculation algorithm includes a changing state and a non-changing state. In one embodiment, the changing state indicates that the calculation algorithm or calculation model of the data are changed, and the non-changing state indicates that the calculation algorithm or calculation model of the data are not changed.

In one embodiment, the registration module 302 further marks the data as continuous data or non-continuous data by determining whether the data are continuous. In one embodiment, the registration module 302 further records the time taken for the data to be calculated according to the calculation algorithm or the calculation model.

The access module 303 accesses the data after registration.

In one embodiment, the access module 303 stores the data after registration. In one embodiment, the registered data are stored in a preset storage location of the storage 12.

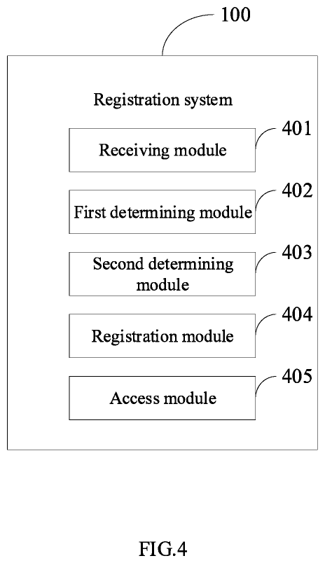

FIG. 4 illustrates the registration system 100. The registration system 100 includes a receiving module 401, a first determining module 402, a second determining module 403, a registration module 404, and an access module 405. The modules 401-405 of the registration system 100 can be collections of software instructions.

The receiving module 401 receives the data sent by the external device 2 and carries out a security check on the data.

In one embodiment, the receiving module 401 selects a checking mode from three checking modes of virus scanning, whitelist scanning, and security authentication, and checks the data according to the selected checking mode. Data shown by the security check result as abnormal is distinguished and reported as abnormal data.

The first determining module 402 determines whether the external device 2 sending the data are registered when the data are not abnormal. In one embodiment, the first determining module 402 determines whether an identification number which is same as the identification number of the external device 2 is in a registration log, and determines that the external device 2 sending the data are registered when such same identification number is found in the registration log, and determines that the external device 2 is not registered when the identification number is not the same in the registration log. In one embodiment, the registration log includes registration information of the data, and the registration information includes, but is not limited to, the identification number of the external device 2, the status of the registration mode of the external device 2, the state of the data's calculation algorithm, the data's calculation algorithm or calculation model, an output interface of the data's calculation results, and an identification number of an output device that outputs the data.

The second determining module 403 acquires the state of the data's calculation algorithm when determining that the external device is registered, and determines whether the state of the data's calculation algorithm is the changing state. In one embodiment, the second determining module 403 acquires the state of the data's calculation algorithm from the registration log.

The registration module 404 registers the data when the external device 2 sending the data are not registered or when the state of the data's calculation algorithm is the changing state.

In one embodiment, the registration module 404 records identification number of the external device 2 that sends the data, records a status of the registration mode of the external device 2, records a state of the data's calculation algorithm, sets the data's calculation algorithm or calculation model, sets output interface of the data's calculation results, and sets identification number of an output device that outputs the data.

In one embodiment, the registration module 404 further marks the data as continuous data or non-continuous data by determining whether the data are continuous. In one embodiment, the registration module 404 further records the time taken for the data to be calculated according to the calculation algorithm or the calculation model.

The access module 405 accesses the data after registration.

In one embodiment, the access module 405 stores the data after registration. In one embodiment, the registered data are stored in a preset storage location of the storage 12.

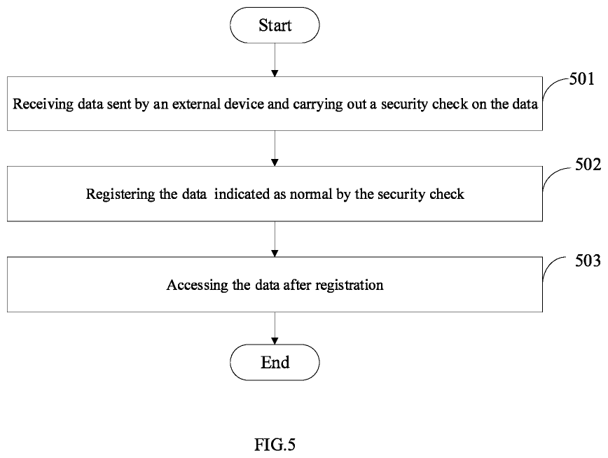

FIG. 5 illustrates a flowchart of an embodiment of a method for registering edge computing access. The registration method is provided by way of example, as there are a variety of ways to carry out the method. The method described below can be carried out using the configurations illustrated in FIGS. 1-4, for example, and various elements of these figures are referenced in explaining the example method. Each block shown in FIG. 5 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 501.

At block 501, an edge computing node device receives data sent by an external device and carries out a security check on the data.

In one embodiment, the edge computing node device receives the data by a communication unit. The edge computing node device selects a checking mode from three checking modes of virus scanning, whitelist scanning, and security authentication, and checks the data according to the selected checking mode, data deemed abnormal according to a security check being recorded, and the abnormal data being distinguished and reported.

In one embodiment, when checking the data according to the checking mode of virus scanning, the edge computing node device compares the data with virus files in a virus database and acquires the result, determining that the data are abnormal when the security check result is that the data are consistent with the virus files in the virus database, otherwise determining that the data are not abnormal. In one embodiment, when checking the data according to the checking mode of whitelist scanning, the edge computing node device compares the data with lists in a whitelist database and acquires the security check result of the data, determining that the data are abnormal when the security check result of the data are that the data are consistent with the lists in the whitelist database, otherwise determining that the data are not abnormal. In one embodiment, when checking the data according to the checking mode of security authentication, the edge computing node device determines that the data are abnormal when the data does not pass security authentication, otherwise determining that the data are not abnormal.

At block 502, the edge computing node device registers the data indicated as normal by the security check.

In one embodiment, the edge computing node device records identification number of the external device that sends the data, records a status of the registration mode of the external device, records a state of the data's calculation algorithm, sets the data's calculation algorithm or calculation model, sets output interface of the data's calculation results, and sets an identification number of an output device that outputs the data.

In one embodiment, the data includes the identification number of the external device, and the edge computing node device records the identification number of the external device when registering the data indicated as normal by the security check. In one embodiment, the identification number of the external device includes, but is not limited to, a device name of the external device, an application field of the external device, a company name of the external device, and a device number of the external device. For example, when the external device is a cloud platform, the identification number of the external device can be Platform_Field_Company_Number; when the external device is an edge computing node device, the identification number of the external device can be EdgeNode_Field_Company_Number; when the external device is an instrument, the identification number of the external device can be T_Instrument_Field_Company_Number. When the external device is a sensor, the identification number of the external device can be T_Instrument_Field_Company_Number.

In one embodiment, the data includes the status of the registration mode of the external device. The status of the registration mode of the external device can include binding and non-binding registration modes. The binding registration mode means that an edge calculation service of the data are fixed, such that a calculation algorithm or a calculation model of the data cannot be changed. In one embodiment, the binding registration mode is suitable for a single terminal device with a relatively simple function, for example, the binding registration mode is suitable for a collector, a sensor, or a controller. In one embodiment, the edge computing node device includes a calculation algorithm or calculation model, and when the data sent by an external device is registered, the edge computing node device registers the calculation algorithm or the calculation model as the calculation algorithm or calculation model of the data. When the data are registered in the binding registration mode, the calculation algorithm or calculation model of the data are fixed and cannot be changed. In one embodiment, the edge computing node device includes a number of calculation algorithms or calculation models, when the data sent by an external device is registered, the edge computing node device selects one calculation algorithm or one calculation model from the number of calculation algorithms or calculation models and registers the selected calculation algorithm or the calculation model in the edge computing node device as the calculation algorithm or calculation model of the data. In another embodiment, the edge computing node device includes a number of calculation algorithms or calculation models and when the data sent by an external device is registered, the edge computing node device selects at least two calculation algorithms or one calculation models from the number of calculation algorithms or calculation models and registers both of the selected calculation algorithms or the calculation models as the calculation algorithm or calculation model of the data.

In one embodiment, the non-binding registration mode means that the edge calculation service of the data can be changed, such that the calculation algorithm or the calculation model of the data can be changed. In one embodiment, the non-binding registration method is suitable for a cloud computing platform, a data center, an edge server, or an edge computing node device. In one embodiment, the edge computing node device includes the computational algorithm or the calculation model, when the data sent by an external device is registered, the edge computing node device registers the calculation algorithm or calculation model as the calculation algorithm or calculation model of the data. When the data are registered in the non-binding registration mode the calculation algorithm or calculation model of the data can be changed.

In one embodiment, the edge computing node device includes a number of calculation algorithms or calculation models, when the data sent by an external device is registered, the edge computing node device selects at least one calculation algorithm or one calculation model from the number of calculation algorithms or calculation models and registers the at least one calculation algorithm or the calculation model in the edge computing node device 1 as the calculation algorithm or calculation model of the data.

In one embodiment, the status of the registration mode is 0 indicates that the registration method is the binding registration mode, and the status of the registration mode is 1 indicates that the registration mode is the nun-binding registration mode. In another embodiment, the status of the registration mode is 0 indicates that the registration method is the nun-binding registration mode, and the status of the registration mode is 1 indicates that the registration mode is the binding registration mode.

In one embodiment, the data includes the state of the data's calculation algorithm. The state of the data's calculation algorithm includes a changing state and a non-changing state. In one embodiment, the changing state indicates that the calculation algorithm or calculation model of the data are changed, and the non-changing state indicates that the calculation algorithm or calculation model of the data are not changed.

In one embodiment, the method further includes: marking the data as continuous data or non-continuous data by determining whether the data are continuous. In one embodiment, the method further includes recording a time taken for the data to be calculated according to the calculation algorithm or the calculation model.

At block 503, the edge computing node device accesses the data after registration.

In one embodiment, the edge computing node device stores the data after registration. In one embodiment, the registered data are stored in a preset storage location of a storage of the edge computing node device.

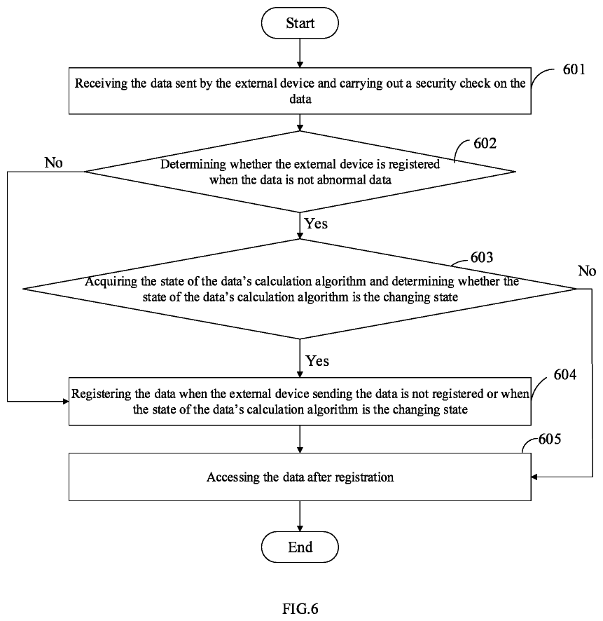

FIG. 6 illustrates another method for registering edge computing access. The method described below can be carried out using the configurations illustrated in FIGS. 1-4, for example, and various elements of these figures are referenced in explaining the example method. Furthermore, the illustrated order of blocks is by example only and the order of the blocks can be changed. Additional blocks may be added or fewer blocks may be utilized, without departing from this disclosure. The example method can begin at block 601.

At block 601, the edge computing node device receives the data sent by the external device and carries out a security check on the data.

In one embodiment, the edge computing node device selects a checking mode from three checking modes of virus scanning, whitelist scanning, and security authentication, and checks the data according to the selected checking mode. Data considered abnormal according to a security check is distinguished and reported.

At block 602, the edge computing node device determines whether the external device sending the data are registered when the data are not abnormal. In one embodiment, the edge computing node device determines whether an identification number identical with the identification number of the external device is in a registration log, and determines that the external device sending the data are registered when an identification number identical with the identification number of the external device is in the registration log, determining that the external device is not registered when an identification number identical with the identification number of the external device is not found in the registration log. In one embodiment, the registration log includes registration information of the data, and the registration information includes, but is not limited to, the identification number of the external device, the status of the registration mode of the external device, the state of the data's calculation algorithm, the data's calculation algorithm or calculation model, an output interface of the data's calculation results, and an identification number of an output device that outputs the data.

At block 603, the edge computing node device acquires the state of the data's calculation algorithm when determining that the external device is registered, and determines whether the state of the data's calculation algorithm is the changing state. In one embodiment, the edge computing node device acquires the state of the data's calculation algorithm from the registration log.

At block 604, the edge computing node device registers the data when the external device sending the data are not registered or when the state of the data's calculation algorithm is the changing state.

In one embodiment, the edge computing node device records identification number of the external device that sends the data, records a status of the registration mode of the external device, records a state of the data's calculation algorithm, sets the data's calculation algorithm or calculation model, sets output interface of the data's calculation results, and sets identification number of an output device that outputs the data.

In one embodiment, the edge computing node device marks the data as continuous data or non-continuous data by determining whether the data are continuous. In one embodiment, the edge computing node device further records the time taken for the data to be calculated according to the calculation algorithm or the calculation model.

At block 605, the edge computing node device accesses the data after registration.

In one embodiment, the edge computing node device stores the data after registration. In one embodiment, the registered data are stored in a preset storage location of the storage.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for registering edge computing access comprising:
receiving data sent by an external device and carrying out a security check on the data;
registering the data indicated as normal by the security check, wherein recording an identification number of the external device that sends the data, recording a status of a registration mode of the external device, recording a state of the data's calculation algorithm, setting the data's calculation algorithm or calculation model, setting output interface of the data's calculation results, and setting an identification number of an output device that outputs the data; and
accessing the data after registration.

2. The method for registering edge computing access according to claim 1, further comprising:
selecting a checking mode from three checking modes of virus scanning, whitelist scanning and security authentication, and checking the data according to the selected checking mode; and
recording abnormal data when a security check result gives abnormal, distinguishing and reporting the abnormal data.

3. The method for registering edge computing access according to claim 1, wherein the identification number of the external device comprises a device name of the external device, an application field of the external device, a company name of the external device, and a device number of the external device.

4. The method for registering edge computing access according to claim 1, wherein the status of the registration mode of the external device comprises a binding registration mode and a non-binding registration mode, the binding registration mode means that a calculation algorithm or a calculation model of the data cannot be changed, and the non-binding registration mode means that the calculation algorithm or the calculation model of the data can be changed.

5. The method for registering edge computing access according to claim 1, wherein the state of the data's calculation algorithm comprises a changing state and a non-changing state, the changing state indicates that the calculation algorithm or calculation model of the data are changed, and the non-changing state indicates that the calculation algorithm or calculation model of the data are not changed.

6. The method for registering edge computing access according to claim 1, further comprising:
marking the data as continuous data or non-continuous data according to whether the data are continuous; and
recording time taken for the data to be calculated according to the calculation algorithm or the calculation model.

7. A method for registering edge computing access comprising:
receiving the data sent by an external device and carrying out a security check on the data;
determining whether the external device sending the data are registered when the data are not abnormal;
acquiring a state of the data's calculation algorithm when determining that the external device is registered, and determining whether the state of the data's calculation algorithm is the changing state, wherein the state of the data's calculation algorithm comprises a changing state and a non-changing state;
registering the data when the external device sending the data are not registered or when the state of the data's calculation algorithm is the changing state; and
accessing the data after registration.

8. The method for registering edge computing access according to claim 7, further comprising:
selecting a checking mode from three checking modes of virus scanning, whitelist scanning and security authentication, and checking the data according to the selected checking mode; and
recording abnormal data when a security check result gives abnormal, distinguishing and reporting the abnormal data.

9. The method for registering edge computing access according to claim 7, wherein the changing state indicates that the calculation algorithm or calculation model of the data are changed, and the non-changing state indicates that the calculation algorithm or calculation model of the data are not changed.

10. The method for registering edge computing access according to claim 7, further comprising:
marking the data as continuous data or non-continuous data according to whether the data are continuous; and
recording time taken for the data to be calculated according to the calculation algorithm or the calculation model.

11. A edge computing node device, comprising:
a processor;
a non-transitory storage medium coupled to the processor and configured to store a plurality of instructions, which causes the processor to:
receive data sent by an external device and carry out a security check on the data;
register the data indicated as normal by the security check, wherein record an identification number of the external device that sends the data, record a status of a registration mode of the external device, record a state of the data's calculation algorithm, set the data's calculation algorithm or calculation model, set output interface of the data's calculation results, and set an identification number of an output device that outputs the data; and
access the data after registration.

12. The edge computing node device according to claim 11, wherein the plurality of instructions is further configured to cause the processor to:
select a checking mode from three checking modes of virus scanning, whitelist scanning and security authentication, and check the data according to the selected checking mode; and
record abnormal data when a security check result gives abnormal, distinguish and report the abnormal data.

13. The edge computing node device according to claim 11, wherein the identification number of the external device comprises a device name of the external device, an application field of the external device, a company name of the external device, and a device number of the external device.

14. The edge computing node device according to claim 11, wherein the status of the registration mode of the external device comprises a binding registration mode and a non-binding registration mode, the binding registration mode means that a calculation algorithm or a calculation model of the data cannot be changed, and the non-binding registration mode means that the calculation algorithm or the calculation model of the data can be changed.

15. The edge computing node device according to claim 11, wherein the state of the data's calculation algorithm comprises a changing state and a non-changing state, the changing state indicates that the calculation algorithm or calculation model of the data are changed, and the non-changing state indicates that the calculation algorithm or calculation model of the data are not changed.

16. The edge computing node device according to claim 11, wherein the plurality of instructions is further configured to cause the processor to:
mark the data as continuous data or non-continuous data according to whether the data are continuous; and
record time taken for the data to be calculated according to the calculation algorithm or the calculation model.
